(19) United States
(12) Patent Application Publication
(10) Pub. No.: US 2010/0122198 A1
(43) Pub. Date: May 13, 2010

(54) Object-Oriented Configuration Methods and Devices for a Phone Switch

(75) Inventors: Stephen Balla, Newark, NJ (US); John Signorello, Oak Ridge, NJ (US)

Correspondence Address: Law Office of Michael J. Feigin, 103 The Circle, (http://PatentLawNY.com), Passaic, NJ, 07055, US

(73) Assignee: ISPBX LLC, Denville, NJ (US)

(21) Appl. No.: 12/266,625

(22) Filed: Nov. 7, 2008

(51) Int. Cl. G06F 3/048; H04M 7/00

(52) U.S. Cl. 715/771; 379/229

(57) ABSTRACT

Disclosed is a visual and cross-platform method and device for configuring both low level processes and high level functions which may be carried out by a phone switch. In methods of the invention, this is accomplished by providing to a user icons representative of the high level functions and, as needed, icons representative of low level processes. The results of the user arrangement of the provided icons allow a script to be written which may be used to program a phone switch.

### FIELD OF THE INVENTION

The disclosure refers generally configuring a phone switch and more specifically to visually configuring phone switches.

### BACKGROUND OF THE INVENTION

Phone switches or exchanges have long been known in the art. Such switches comprise electronic components for connecting telephone calls. Private branch exchanges are switches used by a particular office or business to route calls internally. Such switches, which at one time used to be entirely operated manually, provide an ever increasing array of features and include both circuit-switched, Centrex, and packet-switched networks, as well as combinations thereof.

Phone switches generally carry out processes (low level functions) of 1) establishing a connection between two circuits within a phone system; 2) maintaining such connections, for example by maintaining an electric connection between the circuits or forwarding data from one node to another (as in a packet-switched network); 3) disconnecting such connections; and 4) providing data used for billing a customer. Such processes, which may be used in addition to or in conjunction with the basic functions of a phone switch, may also comprise the elements of dialing, reading or converting DTMF (dual-tone multi-frequency) tones, determining the time of day or day of the week, and so forth.

High level configurations to carry out or combine these basic processes may include automatic dialing, automated directory service (routing of calls to an extension by keying in or speaking letters or parts of a name associated with an extension), automatic ring back, call accounting, call forwarding, call park, call pick-up, call transfer, call waiting, camp-on, conference calling, custom greetings, speed dialing, busy override, do not disturb, follow me service, voice mail, voice paging, and the like. The switches may provide such connections between extensions within a larger phone system, between a calling party and a called party, or from an incoming or outgoing trunk to an extension or a voicemail system or other subsystems within a phone system.

Configuring a phone system, such as a PBX, is a laborious process left to technical people and kept out of reach of the general computer-using population. In view of a plethora of types of phone systems, phone switches, processes, and high level functions, writing a script requires coding and is unfriendly to most. Prior art phone systems may use scripts which, as used in this disclosure, are defined as an unambiguous pathway for electric signals which leads to a specific conclusion, device, or function within a phone system and equivalents thereof. These scripts are often manually programmed and configured, and, though the high level processes described above may be found across a vast array of phone systems and phone switches, such scripts are typically specific to a single type of phone system and require the manual configuration of low level processes.

To further demonstrate the above deficiency of the prior art, it should be understood by one having ordinary skill in the art, that a phone script configured for Asterisk is different from a script written for Call Weaver, Open SIPS or Free Switch. The script for each of these types of phone switches may look very different from the others and require configuration of many processes in the script itself. As disclosed, for example, on the voip-info.org website (accessed Oct. 12, 2008, and submitted in an Information Disclosure Statement with the U.S. version of this application), the following commands would be needed to define even a single extension which answers a call, plays a recording, gives an option of leaving voicemail, and hanging up:
exten→123,1,Answer
exten→123,2,Playback(tt-weasels)
exten→123,3,Voicemail(44)
exten→123,4,Hangup

Thus, the low level processes must be disclosed (i.e., “answer” and “hangup”), as well as the order in which each process should occur (i.e. the four steps for setting up extension 123 above). While some pre-existing script builders add user-friendly features, these systems tend to do nothing more than provide an icon in place of each instruction, which must be manually typed and may actually be less efficient and more time consuming to use than learning the name of each syntax command (i.e., it may be quicker to type “123,4,Hangup” than find the appropriate icon, drag it to the right place, and click through the configuration panels for the icon to ensure it is carrying out the same functions). In either case, whether manual or through the aid of a script builder, the programming or arrangement of a configuration script for a phone system is time-consuming and proprietary.

Especially with the decreasing costs of telephony technology and the advancement of computational power in the hands of individuals and small businesses, there has been a long felt and unsolved need to provide a method of configuring a phone system in a more efficient and easier to use manner.

### SUMMARY OF THE INVENTION

It is therefore an object of the present invention to provide a visual and cross platform method and device for configuring both low level processes and high level functions which may be carried out by a phone switch. In methods of the invention, this is accomplished by providing to a user icons representative of the high level functions (i.e., a conglomeration of processes) and, as needed, icons representative of low level processes (i.e., a single phone switch command or the making or breaking of an electric connection). The results of the user arrangement of the provided icons allow a script to be written which may be used to program a phone switch. The configuration file may be metadata (stored data representing the user manipulations) which may be used to configure a phone switch. A module may be used in conjunction with embodiments of the invention to convert the metadata into a configuration file specific to a type of phone system or a particular phone switch.

A method for aiding configuration of a phone system, in an embodiment of the invention, provides icons representative of at least one high level resource and at least one process to a user, based on a manipulation of the icons by the user, storing data representative of at least one logical pathway between two or more of the at least one high level resource and the at least one process determining a platform of the phone system; and generating platform-specific configuration data for the phone system based on the stored data. The stored data may be metadata. A phone switch may carry out the step of generating. A web server may carry out the step of providing and may further carry out the step of sending the stored data to the phone switch. The phone switch may be configured based on the configuration data.

The configuration data may comprise at least one instruction specific to an inbound call and at least one instruction specific to an outbound call. The at least one high level resource is selected from the group consisting of forwarding, voicemail, and conferencing. The at least one process is selected from the group consisting of dialing, time of day, day of the week, placing a call, disconnecting a call, and examining DTMF tones.

A device for aiding in configuration of a phone system comprising means for providing icons representative of at least one high level resource and at least one process to a user, a data storage apparatus storing data representative of at least one logical pathway between two or more of said at least one high level resource and said at least one process, based on a manipulation of said icons by said user; means for determining a platform of said phone system; and means for generating platform-specific configuration data for a phone system based on the stored data. The stored data may be metadata. The platform-specific configuration data may be generated on a phone switch. The means for providing the icons may comprise the use of a web server, and said web server may further carry out a step of sending the stored data to the phone switch. The phone switch may be configured based on the configuration data. The configuration data may comprise at least one instruction specific to an inbound call and at least one instruction specific to an outbound call.

A computer-readable storage medium may comprise instructions for carrying out the steps of providing icons representative of at least one high level resource and at least one process to a user, based on a manipulation of said icons by said user, storing data representative of at least one logical pathway between two or more of said at least one high level resource and said at least one process, determining a platform of said phone system, and generating platform-specific configuration data for a phone system based on the stored data. A web browser and/or web server may be used to read the instructions or carry out part of the instructions.

### BRIEF DESCRIPTION OF THE DRAWINGS

FIG. 1 shows a high level block diagram of a method of an embodiment of the invention.

FIG. 2 shows a display of components of a telephone system which may be configured in embodiments of the invention.

FIG. 3 shows a display of inbound pathways of a telephone system which may be configured in embodiments of the invention.

FIG. 4 shows a display of outbound pathways of a telephone system which may be configured in embodiments of the invention.

FIG. 5 shows a display of an auto-attendant of a telephone system which may be configured in embodiments of the invention.

FIG. 6 represents a high level block diagram of devices which may be used to carry out embodiments of the invention.

FIG. 7 shows a high level block diagram of a device which may be used in embodiments of the invention.

FIG. 8 shows a high-level block diagram of a computer that may be used to carry out the invention.

FIG. 9 shows an example of extension code being used in an embodiment of the invention.

FIG. 10 shows an example of outbound code being used in an embodiment of the invention.

### DETAILED DESCRIPTION OF EMBODIMENTS OF THE INVENTION

Embodiments of the present invention comprise devices and methods for configuring a script for use on a specific phone system or switch, such as a PBX (private branch exchange) or any device capable of routing telephone calls. In embodiments of the invention, data is provided by a (web) server to a client computing device for visualization of devices of a phone system, as well as high level processes (as defined at least in “Background of the Invention”), the server receiving back data representative of the result of the manipulation of the visual display comprising data representative of at least one operative pathway or high level function to carry out in a phone system, and developing configuration data, such as metadata, which may be or is used to generate a script or code for a phone switch.

The embodiments of the invention will become clear in light of the description of the following figures.

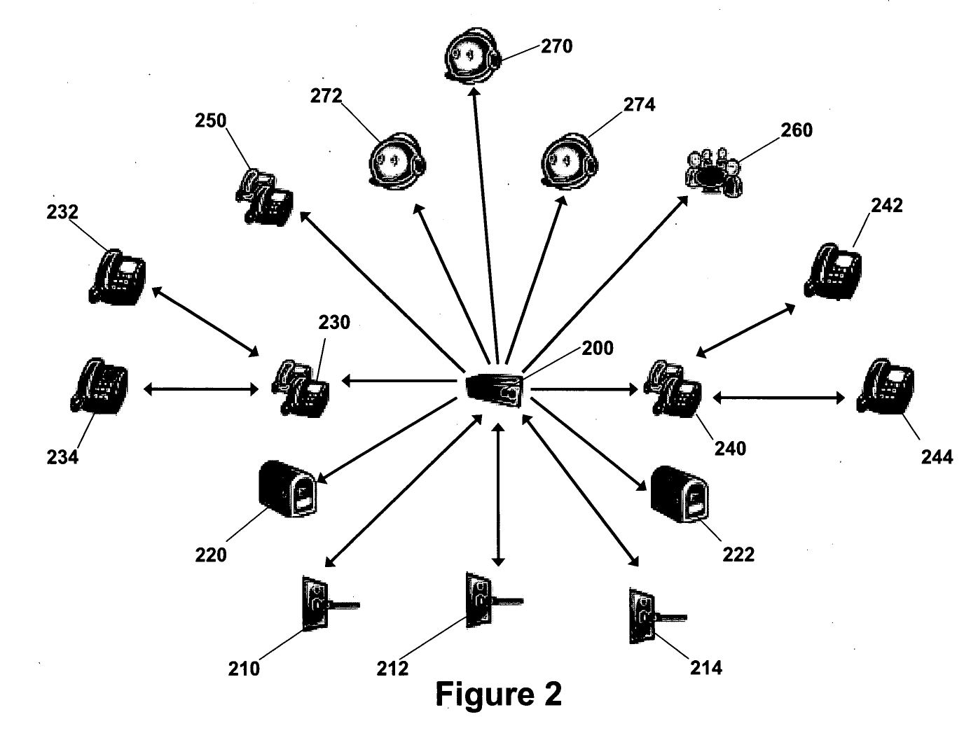

Referring first to FIG. 2, the figure shows a display of components of a telephone system which may be configured in embodiments of the invention. FIGS. 2-5 may also represent an actual visual display of components of high level processes and/or low level functions of a phone system which may be manipulated by a user in order to configure a phone switch or phone system in embodiments of the invention.

Phone switch 200 is operatively connected to various other devices of the phone system shown and/or arranged in FIG. 2. The single and double-headed arrows represent operative connections and direction of flow of data (on a high level) between devices and may be drawn by a user. It should be understood that, typically, data between any two devices which are operatively connected in a phone system flows bi-directionally; however, in the configuration a phone system, many connections are thought of as flowing in one direction. Thus, for example, the arrows extending from the phone switch 200 towards mailboxes 220 and 222 are drawn one-directionally to indicate that the phone call will be handled by the mailbox 220 or 222 and that the mailboxes are endpoints of the switching; i.e., once the call is forwarded to mailbox 220 or 222, voicemail may be left and, typically, the call is ended. It should also be understood that a function or process taking place once the call is being handled by the mailbox 220 or 222 (or any other component of the phone system), the phone call may be passed back to another component if desired.

Referring now to the specific components shown in FIG. 2, trunks 210, 212, 214 represent operative connections between the switch and the respective trunks, a trunk being a phone line or phone lines provided by a telecommunications provider to the phone switch (or other component used in the invention). Group 230 represents one phone (or a bank of phones) which is designated as being part of a group. For example, Group 230 may comprise all phone extensions associated with employees working in the sales department. Extensions 232 and 234 are individual extensions within Group 230. Likewise, extensions 242 and 244 are individual extensions within Group 240. By defining a group, that is by placing and or defining individual telephony devices as extensions associated with a group by drawing or placing arrows between the group identification and an extension, such as from Group 240 to extensions 242 and 244, a call may be routed to any of the extensions shown within the group.

Referring again to FIG. 2, conference 260 and the arrow pointing towards conference 260 designate that a conference call function is configured in the phone system and that, when forwarding to this function, which may be defined in greater detail than shown (as can any of the components shown in FIGS. 2-5), a conference call may be opened up between, for example, an open communication line passing through the phone switch and a new communication line or lines to a pre-designated or inputted phone number, extension, or the like. Extension 250 represents a device capable of receiving or making a telephone call which is not part of Group 230 or 240. Auto-attendants 270, 272, and 274 represent automated processes which may be individually defined and configured, for example, to play designated recordings, decode DTMF tones and respond accordingly, and so on.

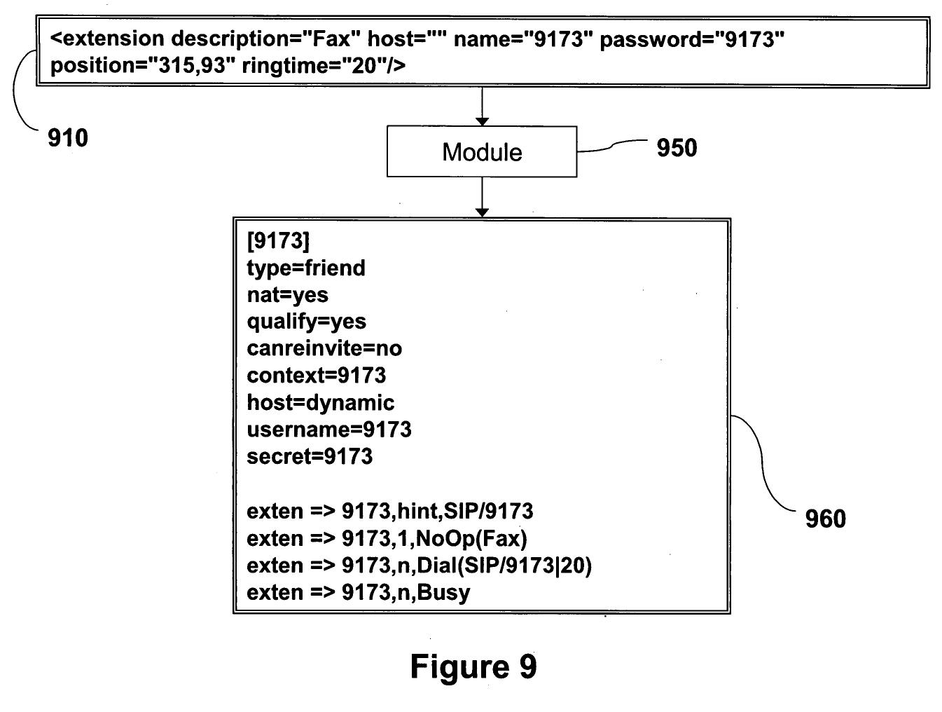

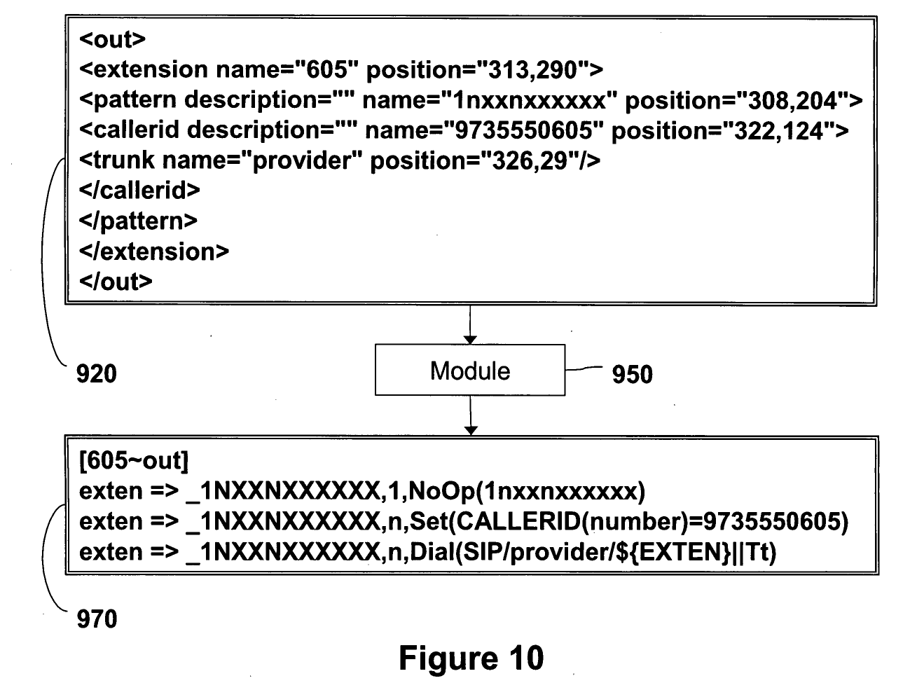

In this manner, many low level processes may be configured automatically, and data representing such an arrangement as shown in FIG. 2 may be stored, such as in metadata, and various phone switches may be configured using the generated data. A module, which may be stored in a separate data file detachable from the code, comprises instructions for carrying out the methods described above with reference to FIG. 2. For example, the module may be a software module for converting the metadata into a script usable to configure a desired switch running any software supported by the module. An example of such a module converting metadata generated from the visual display into code used to configure a phone switch is shown and described with reference to FIGS. 9 and 10 below, and the method of arranging and operatively connecting icons in a visual display in order to configure a phone system will be explained in further detail below.

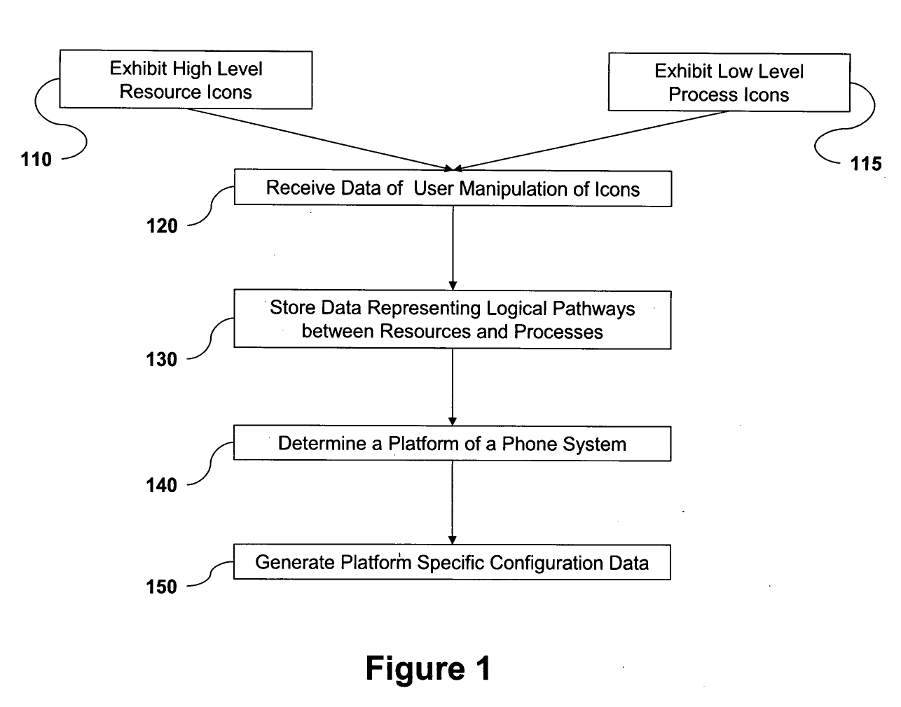

Now referring to FIG. 1, FIG. 1 shows a high level block diagram of a method of an embodiment of the invention. In step 110, high level resource icons are displayed and, in step 115, low level process icons are displayed (such as those described in “Background of the Invention” and with reference to FIG. 2). After or while the user manipulates the icons, data indicating the logical pathways or connections between the icons representing processes and functions to be configured on a phone switch are received. The user may manipulate the icons, such as by placing various icons representative of the resources and/or processes within a visual display and drawing connections—for example, arrows between the resources or processes, as described with reference to FIG. 2 above. For instance, a web server may comprise code which is sent to a web browser on a computing device under the operative control of a user. The code comprises instructions which may be executed in the web browser to display and allow for the manipulation of the icons described in this application on a screen, as well as the defining of the logical pathways between processes and/or functions.

In step 130, data representative of the logical pathways between processes and/or functions is stored, such as on an end-user computing device, where the manipulation took place, and/or on a web server. Then, in step 140, it is determined for which platform a script should be written to configure a phone switch. For example, if it is desired to configure an Asterisk phone system, this may be determined based on an entry or selection by a user at the time of arranging the icons, or before sending a finished script to a phone switch, as part of an automated detection process (such as by querying a phone switch for model number or software implementation), or by uploading the raw configuration data, such as metadata, to a phone switch which comprises a module or code for converting the configuration data into a configuration script for the phone switch. Then, in step 150, platform-specific configuration data is generated.

It should be understood by one skilled in the art that a platform is a hardware architecture or software framework (including application frameworks) that allows software to run. Typical platforms include a computer's architecture, operating system, programming languages and related runtime libraries or graphical user interface. Before delving further into the physical architecture on which embodiments of the invention may be carried out, further methods of manipulating the visual elements representative of processes and functions of a phone system in embodiments of the invention will be described.

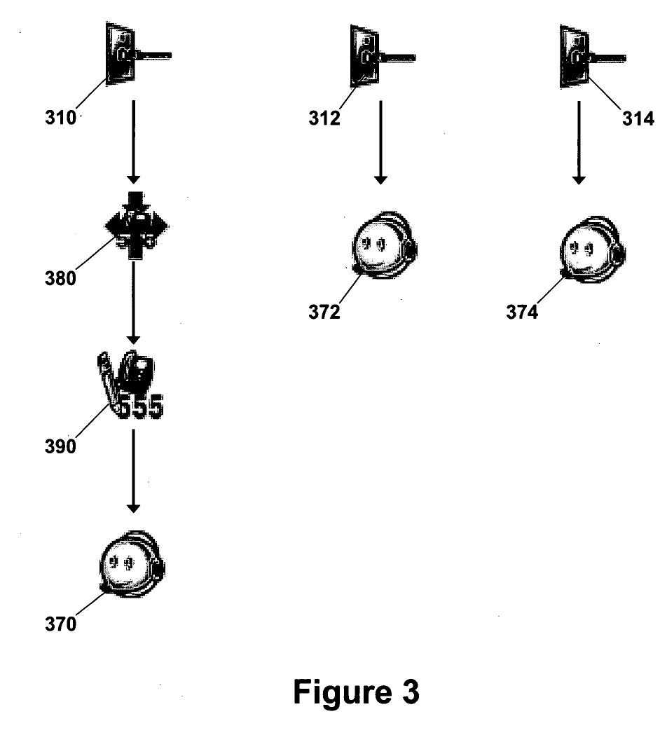

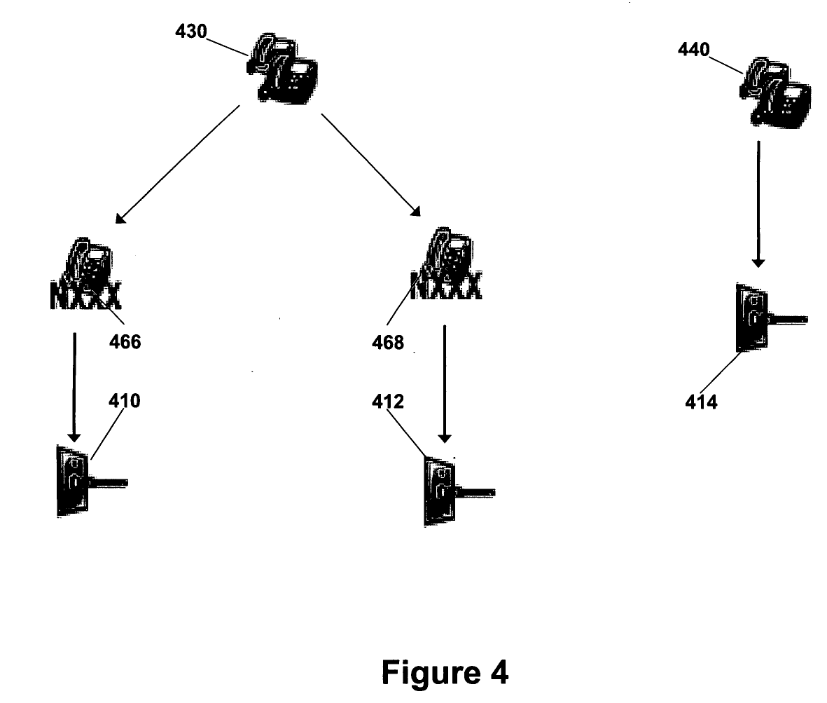

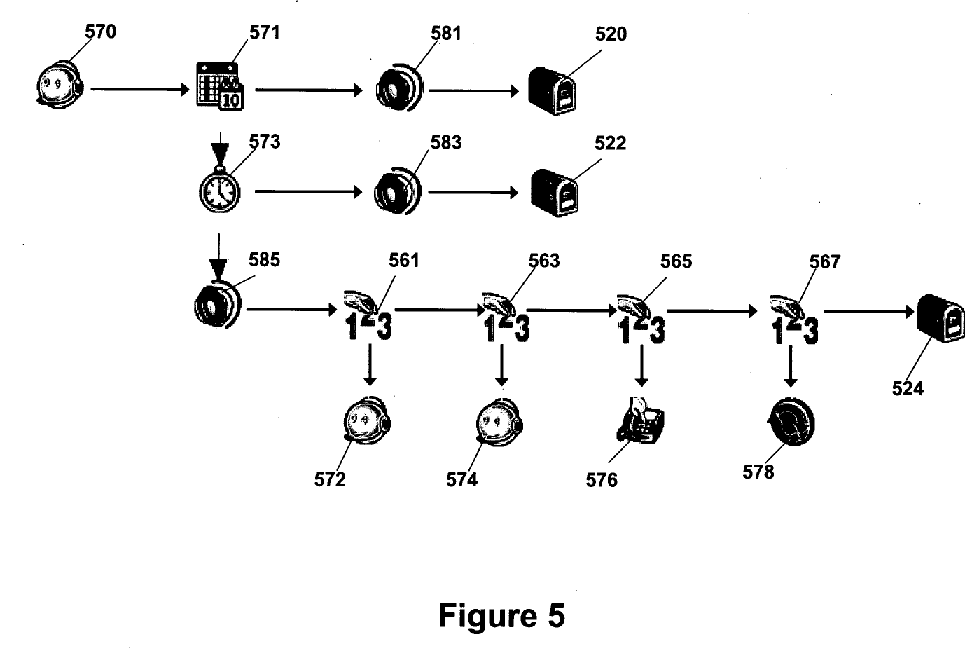

FIG. 3 shows a display of inbound pathways of a telephone system which may be configured in embodiments of the invention. Where practicable, elements described in FIG. 2 have been incremented by 100 in FIG. 3 and have likewise been increased by an additional 100 for each of FIGS. 4 and 5. Calls may come in on any one of trunks 310, 312, or 314. Each trunk may be, for example, associated with a specific telephone number. In the example shown in FIG. 3, if a call comes in on trunk 312, then the call is handled by attendant 372. If a call comes in on trunk 314, then the call is handled by attendant 374. If a call comes in on trunk 310, then the DID (direct inward dialing) number 380 is read, followed by the CallerID (caller identification) information, as represented by CallerID icon 390. If the DID 380 and CallerID 390 match strings as configured for each icon, then the call passes to attendant 370. In order for a user to configure such an embodiment as shown in FIG. 3 (or any one of FIGS. 2-5), the user may drag each icon into position, draw lines between the icons indicating a logical pathway, and configure the properties of each icon.

It should be understood that a user may place any number of trunks, DIDs, CallerIDs, or other functions which, in turn, automatically configure one or more processes as part of the placement of a function in the display and configure conditional activities for the passage of a call to the next icon in the logical pathway. For example, the CallerID icon 370 may be configured to pass the CallerID data on to attendant 370, which is, in turn, configured to play a specific message based on a string in the CallerID data, such as the area code or a match of a phone number with that of a current customer. This may only occur if the DID 380 is an anticipated number. Any scripting possibilities as known in the art of configuring phone switches are within the scope and spirit of the invention in terms of configuring by way of arranging the icons representing functions, icons representing processes, and arrows representing logical pathways of flow of a call between such functions (and/or processes).

FIG. 4 shows a display of outbound pathways of a telephone system which may be configured in embodiments of the invention. If a call is made from extension 440, according to the configuration shown in FIG. 4, the call is placed via trunk 414. If a call is made from extension 430, depending on the number dialed, a call is placed over either trunk 410 or 412. By placing called number icons 466 and 468 between the extension 430 and trunks 410 and 412, and drawing the shown logical pathways by way of the use of arrows, if the called number matches a string defined in called number 466, then the call is placed over trunk 410. If the called number matches a string defined in called number 468, then the call is placed over trunk 412. In this manner, a user may configure the outbound call routing.

FIG. 5 shows a display of an auto-attendant of a telephone system which may be configured in embodiments of the invention. The auto-attendant or attendant is an automated function capable of handling incoming calls based on data garnered from the calling party or low level functions. In the example shown in FIG. 5, a call is forwarded from the switch, such as switch 200, to attendant 570. The attendant 570 may be configured, for example, to answer all calls, all calls received at a certain time, all calls coming in over a certain trunk, or the like. Date icon 571 is placed in a manner which determines the current date of the call. Depending on the date, the call is then processed by one of the functions represented by recording icon 581 or time icon 573. For example, if the call comes in on a Sunday or Saturday, then the date function 571 (shown as date icon 571) may play recording 581 and pass the call to mailbox 520 for receipt of weekend calls. If the call comes in on a Monday-Friday, then time function 573 (shown as time icon 573) may be invoked to determine if it occurs between the hours of 9 am and 5 pm. If not, then a recording 583 is played and the call is passed to mailbox 522. If it takes place between the designated hours, then recording 585 is played.

In embodiments of the invention, each of the elements of time, date, recording, mailbox, and so forth may have default configurations and be associated with one or more processes. That is, for example, mailboxes may be configured to carry out the process of answering the call, playing back a message, recording the call, and hanging up on the call without the user having to configure each individual process separately, though such processes are configured in an automated fashion by way of a user placing a logical pathway to a function.

Continuing the description of FIG. 5, after recording 585 is played, DTMF tones may be read, that is, a digit or digits inputted by a calling party. Similarly, voice commands may be interpreted. Tones 561, 563, 565, and 567 represent a specific digit or set of digits entered, i.e., the number “5,” a three-digit extension number, or the like. By way of example, tone 561 may represent the inputting of number “5” and, upon receiving such an input, the call is forwarded to attendant 572. Tone 563 may represent the inputting of the number “9” and the call is forwarded to attendant 574. Tone 565 may represent the inputting of the digits “123” representing extension 123 and may forward the call to extension 576. Tone 567 may represent inputting of a “*” and cause the repetition 578, whereby recording 585 is played again. If no digit is entered, the call may pass to mailbox 524.

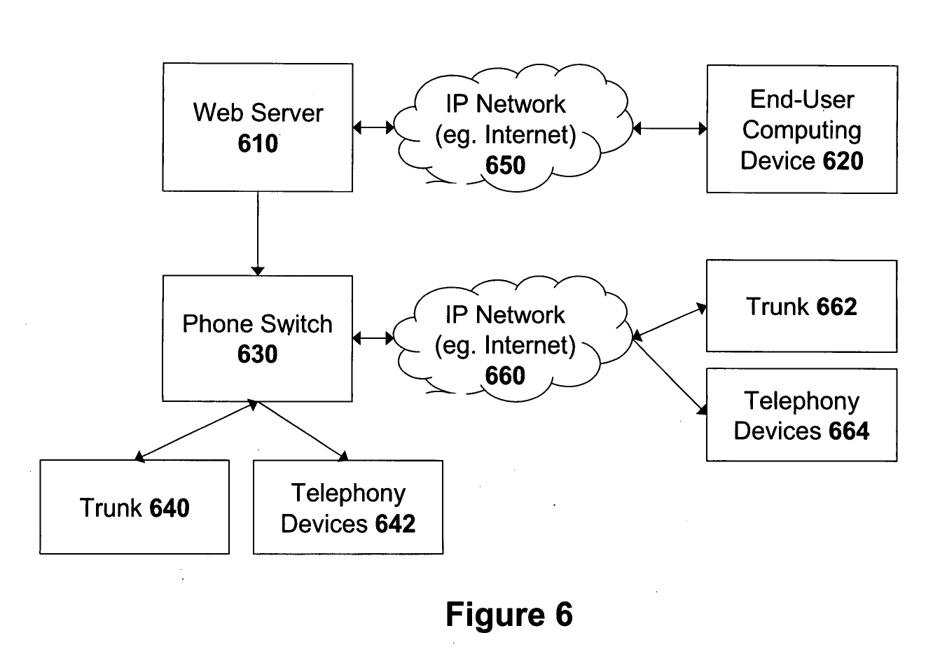

FIG. 6 represents a high level block diagram of devices which may be used to carry out embodiments of the invention. Web server 610 may be any computational device which stores instructions (i.e., code or data) which may be used to instruct a computational device, such as a personal computer, to display data. Such data may include HTML, XML, CSS, Java, JavaScript, Flash, or other code. An end-user computing device 620 typically receives such code from the web server 610 by way of an IP (Internet protocol) network 650 or any packet switched network such as the Internet. One skilled in the art should understand that any means of communicating the data from the web server 610 to the computing device 620, including a serial connection or packet network, may be employed, and that the devices may be one and the same.

In embodiments of the invention, the web server 610 stores code which is executable in a web browser being executed on the end-user computing device 620, which allows a user operating the end-user computing device 620 to manipulate icons and logical pathways, such as those shown in FIGS. 2-5, to arrange a configuration of a phone switch based on the arrangement of high level functions and/or low level processes. Based on such an arrangement, data representative of the arrangement of such functions, processes, and logical pathways between these elements, is stored. The data may be stored on any one of, or multiple of, the devices 610, 620, or 630. Phone switch 630 is a device capable of routing phone calls, as described and defined previously. Any of the devices 610, 620, or 630 may determine the platform of the phone switch 630, and/or may compile the user manipulations of the respective elements into metadata and/or into a script used to configure the phone switch 630.

The phone switch 630 may be connected to one or more trunks, such as trunk 640, and/or one or more telephony devices, such as telephony device 642. The phone switch 630 may be connected to these devices via direct connection to the switch itself or may communicate with these devices over a packet switched network, for instance an IP network 660 such as the Internet. In this manner, trunk 662 and telephony device 664, by way of example, may be under the operative control or receive telephony service from or to the telephone switch 630 anywhere on the network, whether local or remote. IP network 650 and IP network 660 may be the same network.

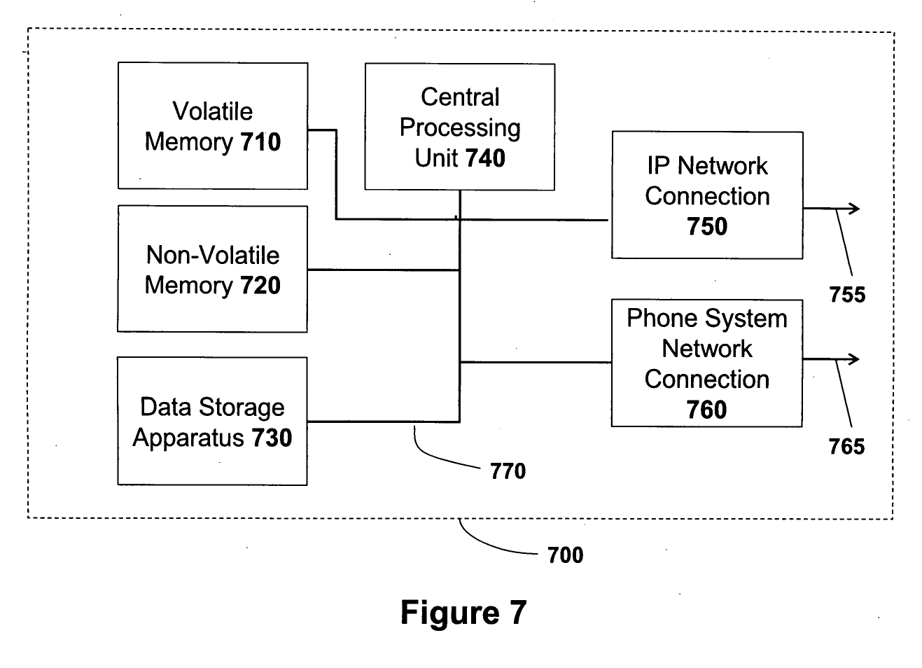

FIG. 7 shows a high level block diagram of a device which may be used in embodiments of the invention. The device 700 may be a phone switch, web server, end user computational device, or the like, and is generally known in the art. When used as a phone switch, typically one or more phone system network connections 760 are available to connect into a phone system, such as by way of a fiber optic or RJ45 cable. Connection into a phone system may also be by way of the IP network connection 750, or, as is commonly referred to in the art, “an Ethernet connection.” The IP network connection 750 may also provide network connectivity and be the mechanism for receipt of metadata or configuration data for configuring a phone switch. The phone switch may further carry out of the functions of a web server, such as web server 610, and provide data for display on an end-user computing device 620. The device may further comprise a bus 770 for transport of data between elements of the device of FIG. 7. A data storage apparatus 730 may be used for permanent or long term storage of data and may be magnetic, optical, or another type of medium known in the art. Central processing unit 740 receives and carries out instructions. Volatile memory 710 is typically erased upon losing power and may be rewritten, and non-volatile memory 720 is typically read-only memory and/or used for long term storage of data.

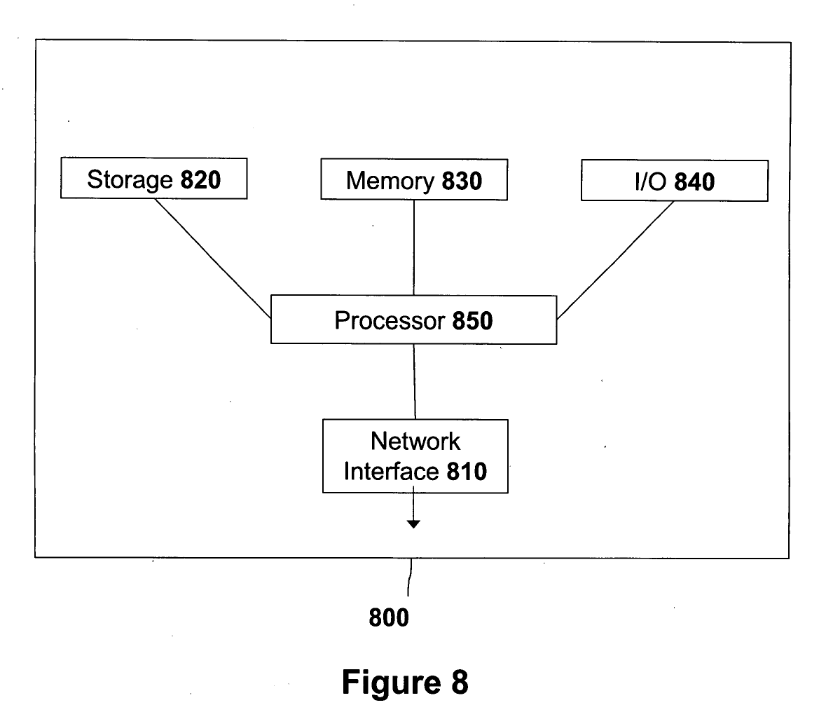

FIG. 8 shows a high-level block diagram of a computer that may be used to carry out the invention. Computer 800 contains a processor 804 that controls the overall operation of the computer by executing computer program instructions which define such operation. The computer program instructions may be stored in a storage device 808 (e.g., magnetic disk, database) and loaded into memory 812 when execution of the computer program instructions is desired. Thus, the computer operation will be defined by computer program instructions stored in memory 812 and/or storage 808, and the computer will be controlled by processor 804 executing the computer program instructions. Computer 800 also includes one or a plurality of input network interfaces for communicating with other devices via a network (e.g., the Internet). Computer 800 also includes one or more output network interfaces 816 for communicating with other devices. Computer 800 also includes input/output 824, representing devices which allow for user interaction with the computer 800 (e.g., display, keyboard, mouse, speakers, buttons, etc.).

One skilled in the art will recognize that an implementation of an actual computer will contain other components as well, and that FIGS. 7-8 especially, and the figures in general, are a high level representation of some of the components of a computer or switch and are for illustrative purposes. It should also be understood by one skilled in the art that the method and devices depicted or described in FIGS. 1 through 7 may be implemented on a device such as is shown in FIGS. 7 and 8.

FIG. 9 shows an example of extension code being used in an embodiment of the invention. Metadata 910 is an example of code generated using device or methods of the invention shown and described with reference to the previous figures. Module 950 is a specific set of computer readable instructions for carrying out a conversion of data, such as metadata 910, to data used to configure a phone switch, such as phone switch 200. Referring back to FIGS. 1 and 2, the metadata 910 may be the code generated in steps 110 and 120 as a result of extension 250 being placed into a visual configuration of a phone system. Each XML element (extensible markup language element) is defined as is known in the art, i.e. “name=‘9173’” is interpreted as “the name is 9173” in plain English. Module 950, which may be executed in the web browser of a user, on the web server, on a switch 200, or any other computing device, interprets the high level process being defined in extension 250 and generates instructions for a specific phone system. In this example, code for an Asterisk phone system is shown as the output code 960 and would be understood by one having skill in the art of phone system programming and an Asterisk phone system.

FIG. 10 shows an example of outbound code being used in an embodiment of the invention. Metadata 920 represents the code generated by placement of elements 310, 370, 380, and 390 of FIG. 3. It should be noted that the position refers to the X and Y coordinates in which each element was placed. The module 950 interprets the generated metadata 920 and converts the code into desired code for configuring a switch 200 for outbound calls as shown in the output code 970, in this case, for an Asterisk phone system or switch.

In this manner, a user configuring a phone system need only configure the high level function of an “extension” and have each line of code used to configure one of many different types of phone switches or phone systems configured as part of an automated process.

While the invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A method for aiding in configuration of a phone system comprising:
providing icons representative of at least one high level resource and at least one process to a user;
based on a manipulation of said icons by said user, storing data representative of at least one logical pathway between two or more of said at least one high level resource and said at least one process;
determining a platform of said phone system; and
generating platform-specific configuration data for a phone system based on said stored data.

2. The method of claim 1, wherein said stored data is metadata.

3. The method of claim 1, wherein a phone switch carries out said step of generating.

4. The method of claim 3, wherein a web server carries out said step of providing and said web server further carries out a step of sending said stored data to said phone switch.

5. The method of claim 3, wherein said phone switch is configured based on said configuration data.

6. The method of claim 3, wherein said configuration data comprises at least one instruction specific to an inbound call and at least one instruction specific to an outbound call.

7. The method of claim 1, wherein said at least one high level resource is selected from the group consisting of forwarding, voicemail, and conferencing.

8. The method of claim 1, wherein said at least one process is selected from the group consisting of dialing, time of day, day of the week, placing a call, disconnecting a call, and examining DTMF tones.

9. A device for aiding in configuration of a phone system comprising:
means for providing icons representative of at least one high level resource and at least one process to a user;
a data storage apparatus storing data representative of at least one logical pathway between two or more of said at least one high level resource and said at least one process based on a manipulation of said icons by said user;
means for determining a platform of said phone system; and
means for generating platform specific configuration data for a phone system based on said stored data.

10. The device of claim 9, wherein said stored data is metadata.

11. The device of claim 9, wherein said platform-specific configuration data is generated on a phone switch.

12. The device of claim 11, wherein said means for providing said icons comprise the use of a web server and said web server further carries out a step of sending said stored data to said phone switch.

13. The device of claim 11, wherein said phone switch is configured based on said configuration data.

14. The device of claim 11, wherein said configuration data comprises at least one instruction specific to an inbound call and at least one instruction specific to an outbound call.

15. A computer-readable storage medium comprising instructions for carrying out the steps of:
providing icons representative of at least one high level resource and at least one process to a user;
based on a manipulation of said icons by said user, storing data representative of at least one logical pathway between two or more of said at least one high level resource and said at least one process;
determining a platform of said phone system; and
generating platform specific configuration data for a phone system based on said stored data.

16. The computer-readable storage medium of claim 1, wherein said stored data is metadata.

17. The computer-readable storage medium of claim 1, wherein said instructions for generating platform-specific configuration data are carried out by a phone switch.

18. The computer-readable storage medium of claim 17, wherein said instructions for providing icons are carried out by a web browser, and a web device sends said stored data to said phone switch.

19. The computer-readable storage medium of claim 17, wherein said phone switch is configured based on said configuration data.

20. The computer-readable storage medium of claim 17, wherein said configuration data comprises at least one instruction specific to an inbound call and at least one instruction specific to an outbound call.
